(19) United States
(12) Patent Application Publication
(10) Pub. No.: US 2008/0121196 A1
(43) Pub. Date: May 29, 2008

(54) Internal-Combustion Engine With Guided Roller Piston Drive

(76) Inventor: Luciano Fantuzzi, Brescello (IT)

Correspondence Address: COLLARD & ROE, P.C., 1077 NORTHERN BOULEVARD, ROSLYN, NY, 11576, US

(21) Appl. No.: 11/793,872

(22) PCT Filed: Dec. 22, 2005
(86) PCT No.: PCT/EP05/57081

§ 371 Date: Jun. 21, 2007

(30) Foreign Application Priority Data
Dec. 23, 2004 (IT) MO2004A000345

(51) Int. Cl. F02B 75/24

(52) U.S. Cl. 123/55.2; 123/197.4

(57) ABSTRACT

An internal-combustion engine (1) with improved reciprocating operation comprises at least one hollow cylinder (C), which contains a chamber for the evolution of a working fluid and has one end closed by a head and the opposite end closed by a piston (2) which can slide with a reciprocating rectilinear motion between a bottom dead center (BDC) and a top dead center (TDC), and a device (3) for converting the reciprocating rectilinear motion of the piston (2) into a rotary motion of an engine shaft (4) which comprises a push rod (5), which is substantially perpendicular to the engine shaft (4) and in which a first end (5a) is connected to the piston (2) and a second end (5b) is connected to at least one pin (13) for supporting at least one pusher roller (7) and at least one return roller (8), which rotate in mutually opposite directions, a rotating contoured body (9), which is fixed to the engine shaft (4) and is provided with at least one pusher circuit (10) and at least one return circuit (11), along which the respective rollers (8) travel, at least one guiding arm (12), in which one end is associated with the roller supporting pin (13) and the opposite end is articulated so that it can move about a fixed axis (D); the pusher and return circuits (10, 11) comprise respective circular arcs for the sliding of the pusher and return rollers (7, 8) which, when the piston (2) is proximate to the top dead center, are suitable to keep the push rod (5) and the piston (2) in a substantially stationary configuration over a predefined space or angle of rotation of the rotating contoured body, the volume of the chamber remaining substantially constant until explosion has occurred.

### TECHNICAL FIELD

The present invention relates to an internal-combustion engine with improved reciprocating operation.

### BACKGROUND ART

It is known that internal-combustion engines allow to convert the energy produced by the fuel into mechanical work by means of the working fluid inside the combustion chamber.

Engines have a cyclic operation which comprises the steps of intake, compression, combustion or expansion, and discharge of the residual fluid in the form of unburned gases.

The work cycles of known types of internal-combustion engine can be approximated by means of the Sabathé ideal thermodynamic cycle, which reproduces ideally the combustion process with two transformations: the first one at constant volume and the second one at constant pressure.

The first two ideal thermodynamic cycles, which are simplifications of the Sabathé cycle, are known: the Otto cycle, in which combustion is represented by means of a constant-volume transformation, and the Diesel cycle, in which combustion is represented by means of a constant-pressure transformation.

Part of the loss of thermodynamic efficiency of the actual work cycle of an engine with respect to the efficiency of an ideal thermodynamic cycle is unquestionably due to the way in which the combustion process occurs and to the connections of the pusher linkage system, i.e., to thermodynamic and mechanical efficiency.

The connecting mechanisms of traditional engines are constituted by connecting rod-and-crank systems, which allow to convert the reciprocating rectilinear motion of the piston into a rotary motion of the engine shaft.

The piston is connected to the engine shaft by means of a connecting rod, in which the small end is pivoted to the piston pin and the big end is coupled to the crankshaft of the engine.

The small end moves with a reciprocating rectilinear motion together with the respective piston, while the big end moves with a rotary motion.

There are also known internal-combustion engines of the spark-ignition or compression-ignition type with reciprocating operation which are constituted by at least one cylinder, inside which a piston is accommodated so that it can slide with a reciprocating rectilinear motion; said piston is connected to a device for converting its rectilinear motion into the rotary motion of an engine shaft, which has characteristics which are different from the connecting rod-and-crank mechanism.

These motion conversion devices, which are of a known type yet have never been disclosed and used so far, are constituted essentially by a push rod and by a helical rotating contoured body, which is fixed to the engine shaft; an edge is formed at the end faces of the contoured body along the entire perimeter of the circuit, in which the outer profile forms a pusher track and the internal profile forms a return track.

These rotating bodies have been conceived in a plurality of versions by various designers and with two or more lobes, but the prototypes that have been produced have not yielded the expected results and therefore have been abandoned.

In these devices, the push rod moves with a reciprocating motion only in the vertical direction, differently from what occurs in devices of the known connecting rod-and-crank type, in which the small end of the connecting rod moves with a reciprocating rectilinear motion and the big end moves with a rotary motion about the engine shaft; therefore, the shank of the connecting rod has a composite alternating rotary oscillating motion.

These known types of internal-combustion engine with reciprocating operation, in particular with a connecting rod-and-crank mechanism, have some important drawbacks which are due to an inflexible method of operation, which up to now it has not been possible to avoid.

These engines in fact have much lower thermodynamic efficiencies than the ideal ones predicted by Otto and absolutely do not allow constant-volume combustion, with the consequent drawback of having to use large quantities of fuel in order to obtain limited amounts of power.

If one considers the fact that the aspirated fluid is used only partially—and specifically to a maximum extent of 30-35%—this leads to noxious emissions of unburned gases into the atmosphere in an amount equal to approximately 65-70% of the intake fluid.

This leads to high specific consumptions in order to deliver low power levels, differently from ideal engines with constant-volume combustion.

A further drawback of known engines is that when the respective pistons move from the top dead center to the bottom dead center and vice versa, lateral thrusts are discharged onto them (and therefore onto the entire mechanism) and absorb considerable energy and produce deformations on the cylinders and pistons, generating wear and noise of the mechanical type (so-called “piston slap”), shortening and also worsening the performance and life of said engines.

### DISCLOSURE OF THE INVENTION

The aim of the present invention is to eliminate in the best possible manner the drawbacks of known engines, by providing an internal-combustion engine with improved reciprocating operation, which can operate with any fuel, has higher thermal and mechanical efficiency, delivers a higher specific power for an equal displacement and rpm rate, and can achieve a higher rotation rate of the piston (or pistons) as a function of the system used even with respect to the engine shaft.

An object of the present invention is to provide an engine in which the masses that perform reciprocating and rotary motions have a low value in terms of friction and lateral thrusts in order to avoid stress affecting the pistons.

An object of the invention is in fact to eliminate these abnormal thrusts, thus recovering all the energy dissipations absorbed in known engines, utilizing all the power that can be delivered and further avoiding wear and ovalization of the cylinders and pistons as well as all mechanical noise.

Another object of the present invention is also to provide an internal-combustion engine with improved reciprocating operation which allows to improve the thermodynamic efficiency of the work cycle by obtaining a controlled and adjustable combustion at constant volume, such as the one predicted ideally by the Otto cycle and never provided anywhere in the world before now, with the goal of reducing specific fuel consumption and of yielding, for an equal amount of aspirated fluid, at least twice the power for an equal displacement and rpm rate, always with the possibility to control and modify the duration of the step of combustion at constant volume, thus reducing a good fraction (50% and more) of polluting emissions.

Other objects of the present invention consist in increasing the ratio between power output and engine weight and between power output and engine size; in simplifying the elements for transmitting the power transmitted to the engine shaft, facilitating the engine-gearbox coupling, at least halving the rpm rate of the engine shaft with respect to the rpm rate of the piston, further achieving a considerable reduction of the imbalances and consequent vibrations of reciprocating masses, thus achieving particularly high maximum torque values at low rpm rates.

This aim and these objects are achieved by the present internal-combustion engine with improved reciprocating operation, which comprises at least one hollow cylinder, which contains a chamber for the evolution of a working fluid and has one end closed by a head and the opposite end closed by a piston which can slide with a reciprocating rectilinear motion in said chamber between a bottom dead center, providing the maximum distance from said head, and a top dead center, providing the minimum distance from said head, and a device for converting the reciprocating rectilinear motion of said piston into a rotary motion of an engine shaft, characterized in that said conversion device comprises:
a push rod, which is substantially perpendicular to said engine shaft and in which a first end is connected to said piston and a second end is connected to at least one pin for supporting at least one pusher roller and at least one return roller; said rollers rotating in mutually opposite directions and being arranged so that their axis is substantially parallel to said engine shaft;
a rotating contoured body, which is fixed to said engine shaft and is provided with at least one pusher circuit, along which said pusher roller travels, and at least one return circuit, along which said return roller travels, arranged on a plane which is perpendicular to said engine shaft; said pusher circuit is substantially concentric and similar to said return circuit, and both circuits are arranged on two different planes inside or outside said contoured body;
at least one guiding arm, in which one end is associated with said pin for supporting said rollers and the opposite end is articulated so that it can move about an axis which is fixed and rigidly coupled to the structure of the engine and is substantially parallel to said engine shaft;
said pusher and return circuits comprising respective circular arcs for the sliding of said pusher and return rollers which, when the piston is proximate to said top dead center, are suitable to keep the push rod and the piston in a substantially stationary configuration over a predefined space or angle of rotation of said rotating contoured body, the volume of said chamber remaining substantially constant until explosion has occurred.

### BRIEF DESCRIPTION OF THE DRAWINGS

Further characteristics and advantages of the present invention will become better apparent from the following detailed description of some preferred but not exclusive embodiments of an internal-combustion engine with improved reciprocating operation, illustrated by way of non-limiting example in the accompanying drawings, wherein:

FIG. 1 is a schematic perspective view of a portion of the engine according to the invention;

FIG. 2 is an exploded schematic view of the rotating contoured body of the engine of FIG. 1;

FIG. 3 is an exploded schematic view of some details of the engine of FIG. 1;

FIG. 4 is a schematic sectional view of some details of the engine of FIG. 1;

FIG. 5 is a schematic sectional view of some details of the engine of FIG. 1;

FIG. 6 is a schematic perspective view of the rotating contoured body and of the corresponding components of an alternative embodiment of the engine according to the invention;

FIG. 7 is a schematic sectional view of some details of the alternative embodiment of the engine according to the invention;

FIG. 8 is a schematic plan view of the profile of a possible embodiment of the rotating contoured body of the engine according to the invention;

FIG. 9 is a perspective view of the two-cylinder engine according to the invention;

FIG. 10 is a perspective view of the engine with four cylinders, all of which work on the same rotating contoured body and on the same engine shaft according to the invention;

FIG. 11 is an axonometric view of the engine with eight or more cylinders according to the invention;

FIG. 12 is a schematic plan view of the profile of a second possible embodiment of the rotating contoured body of the engine according to the invention;

FIG. 13 is a schematic plan view of the profile of a third possible embodiment of the rotating contoured body of the engine with four lobes according to the invention.

### WAYS OF CARRYING OUT THE INVENTION

With reference to the figures, the reference numeral 1 generally designates an internal-combustion engine with improved reciprocating operation.

The engine 1 comprises at least one and preferably a plurality of hollow cylinders C, which have one end closed by a head T, in which there are ports for feeding the fluid and for discharging the unburned gases which are controlled by respective valves, and the opposite end closed by a piston 2, which can slide with a reciprocating rectilinear motion within said cylinder.

The working fluid evolves thermodynamically within a chamber formed by the walls of the cylinder, by the piston 2 and by the head T.

The piston 2 moves, as in conventional engines, between a top dead center (TDC), providing the minimum distance from the head of the cylinder, and a bottom dead center (BDC), providing the maximum distance from the head of the cylinder.

Differently from known engines and according to the invention, a device 3 for converting the reciprocating rectilinear motion of said piston into a rotary motion of an engine shaft 4 having a longitudinal axis A is associated with each piston 2.

The device 3 comprises a push rod 5, which is substantially perpendicular to the axis A and has a first end 5a, which is associated by means of a pin 6 with the piston 2, and a second end 5b, which is connected to at least one supporting pin 13 with a rotary coupling; at least one pusher roller 7 and at least one return roller 8 are accommodated on the pin 13, are substantially mutually coaxial and have an axis B which is substantially parallel to the axis A.

The device 3 further comprises a rotating contoured body 9, which is fixed to the engine shaft 4 and inside which there is at least one pusher circuit 10, along which the pusher roller 7 travels, and at least one return circuit 11, along which the return roller 8 travels.

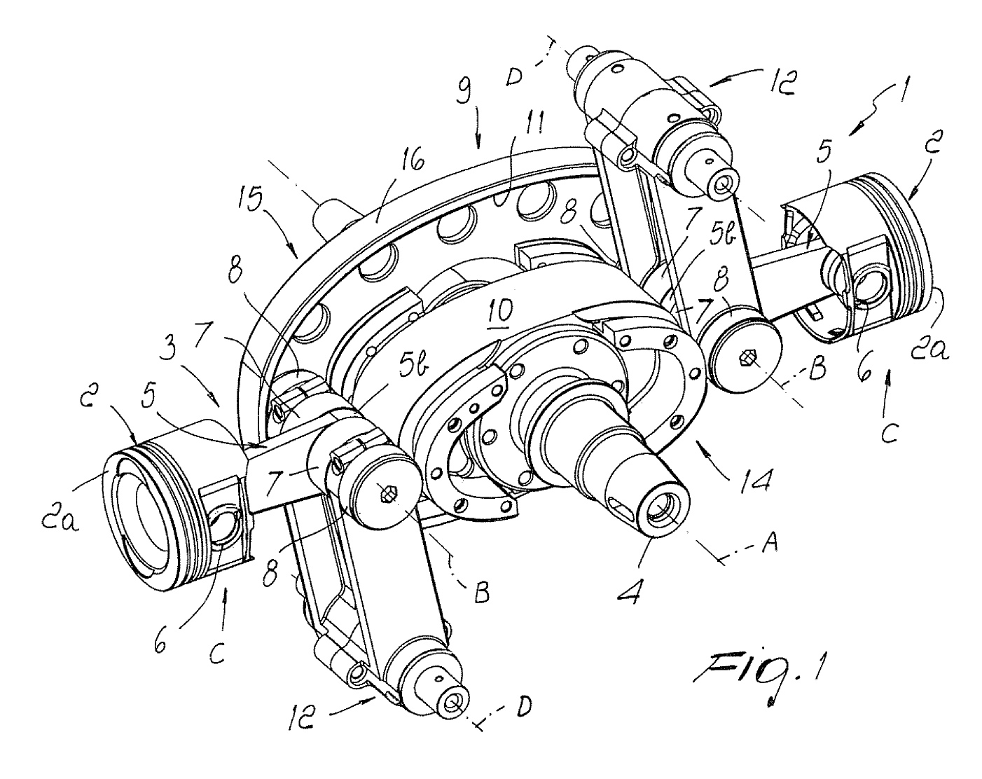

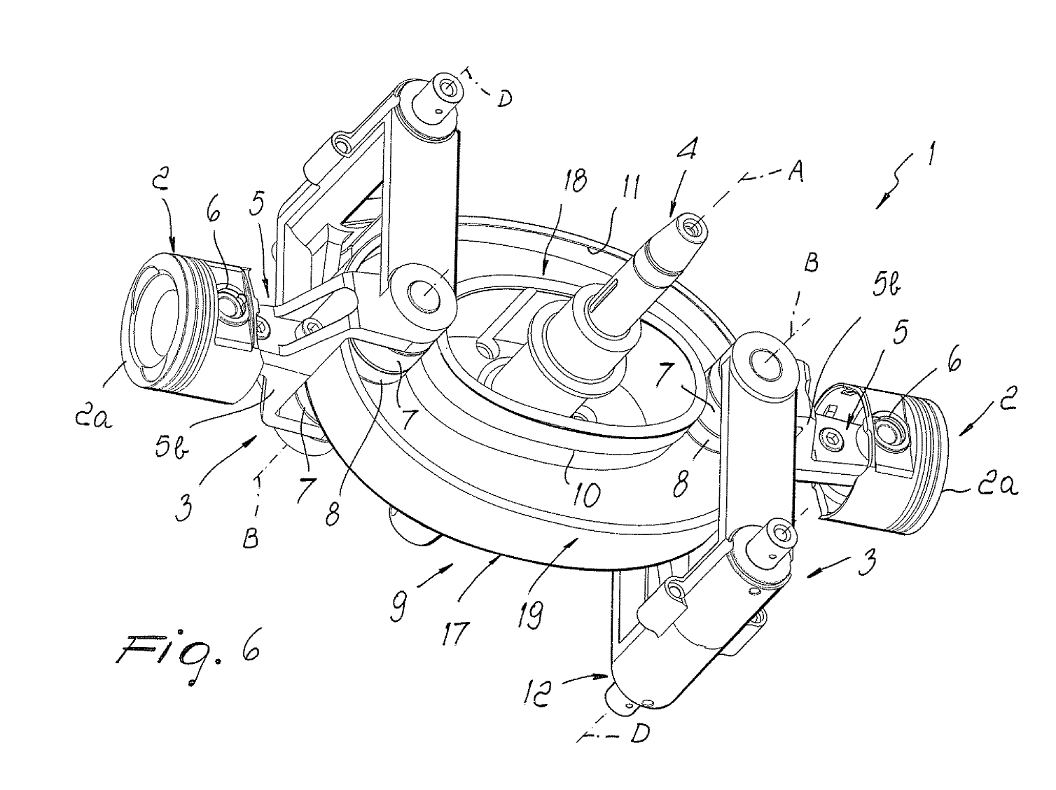

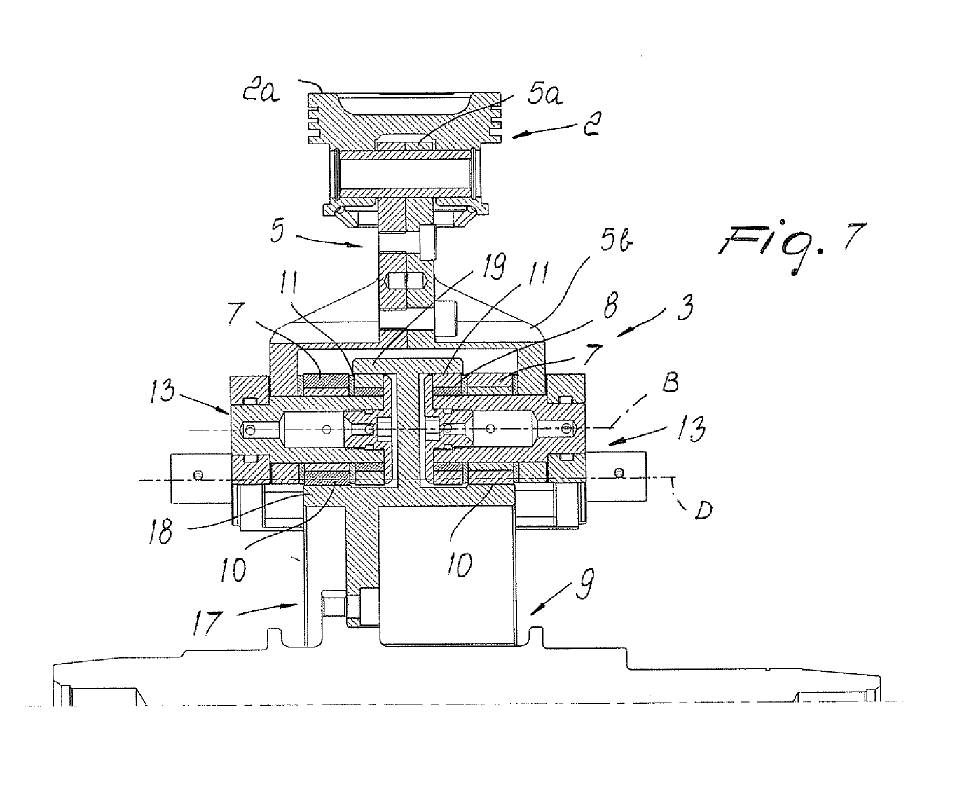

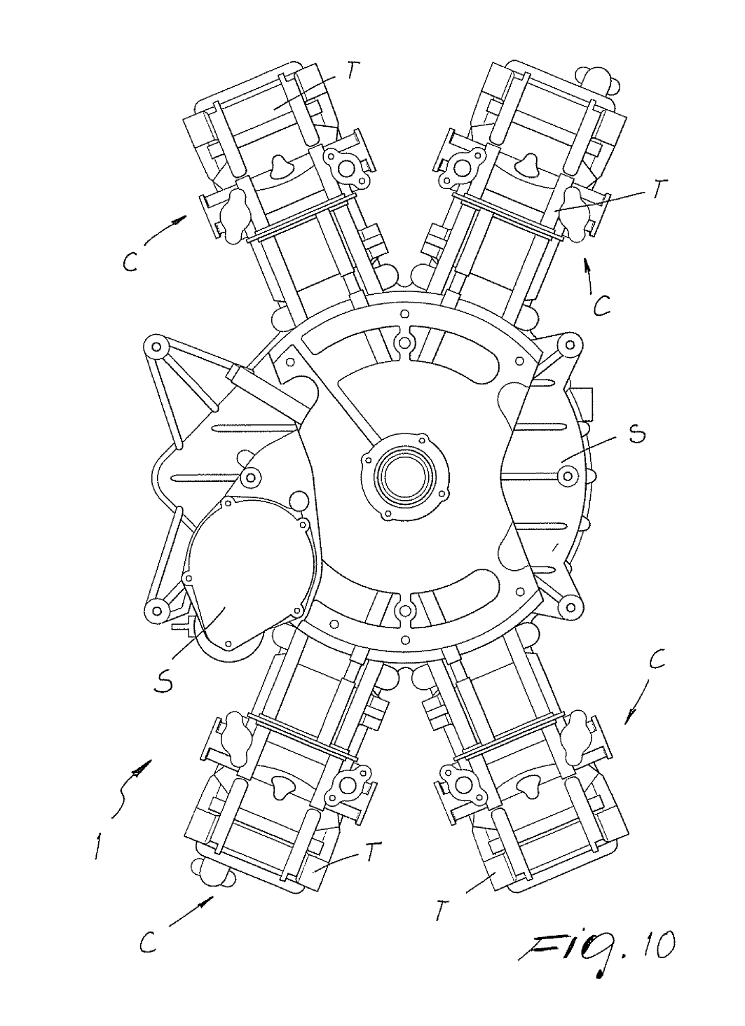

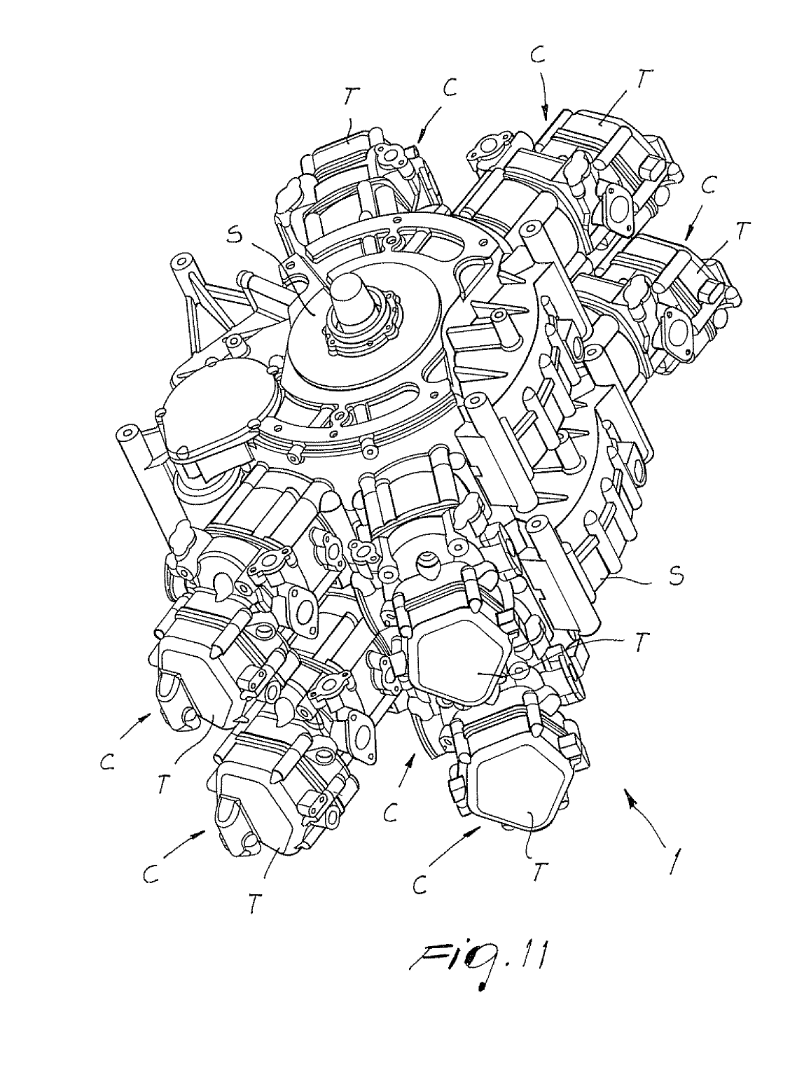

In the particular embodiments shown in FIGS. 1 and 6, the cylinders are two and are mutually opposite, but alternative embodiments with one, three, four (FIG. 10), eight (FIG. 11) or more cylinders on the same rotating contoured body are not excluded, with the possibility to arrange side by side a plurality of rotating bodies having the same number of cylinders so as to be able to provide a plurality of cylinders on the same engine assembly, in order to obtain modular engines with high power, both in terms of displacement and in terms of number of cylinders.

Projected onto a plane which is perpendicular to the engine shaft 4, the pusher circuit 10 is substantially concentric and similar and internal with respect to the return circuit 11; the pusher circuit 10 and the return circuit 11 are mutually parallel, but can also lie on different planes.

The device 3 further comprises at least one and preferably two guiding arms 12, in which a first end is associated with the pin 13, which supports the second end 5b of the push rod 5, and the pusher and return rollers 7 and 8, and the opposite end is articulated so that it can move about an axis D which is fixed to the structure S of the engine and is substantially parallel to the axis A, forming an oscillating rigid structure.

The pusher rollers 7 and the return rollers 8 are mounted so that they rotate about a single supporting pin 13, which forms the axis B; however, alternative embodiments are also possible in which the return rollers and the pusher rollers are mounted on respective pins which are mutually separate and different.

Conveniently, the rollers 7 and 8 may be replaced with technically equivalent components, such as sleeve bearings, sliding blocks, rolling bearings and the like.

An important detail is that an invention has been devised which allows the rollers to rotate freely in mutually opposite directions, each one traveling on its own dedicated circuit, eliminating contact when the reversal of the rotation of the contoured body occurs due to the physical effect of the mechanism and eliminating accordingly the sudden reversal of rotation of said rollers.

The pusher rollers 7 feed and control the rotation of the rotating contoured body 9; at a certain angle of rotation of the contoured body, the pusher rollers no longer touch the corresponding circuit 10 and at the same time the return rollers make contact with the respective circuit 11.

By means of this invention, the system is allowed to follow equally the motion depending on the thrust that it receives; the pusher rollers 7 in fact rotate in the opposite direction with respect to the return rollers 8, so as to avoid friction and slippage phenomena, since the pusher and return rollers are never simultaneously in contact with the corresponding circuits, due to the profiles of said circuits, which remain in contact with the rollers only in the portion of the rotation preset by the direction of rotation of the individual rollers when it is necessary to achieve contact.

It is noted that what has been described above is ensured by the geometry of the circuits and by their relative arrangement in space.

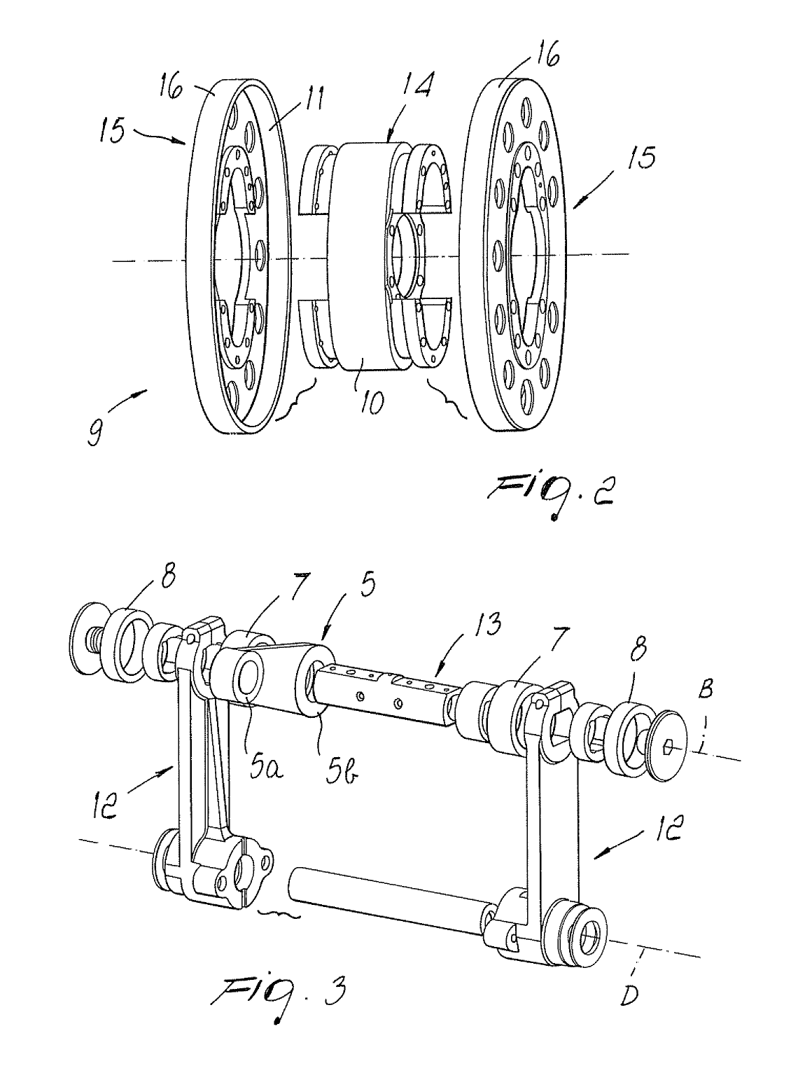

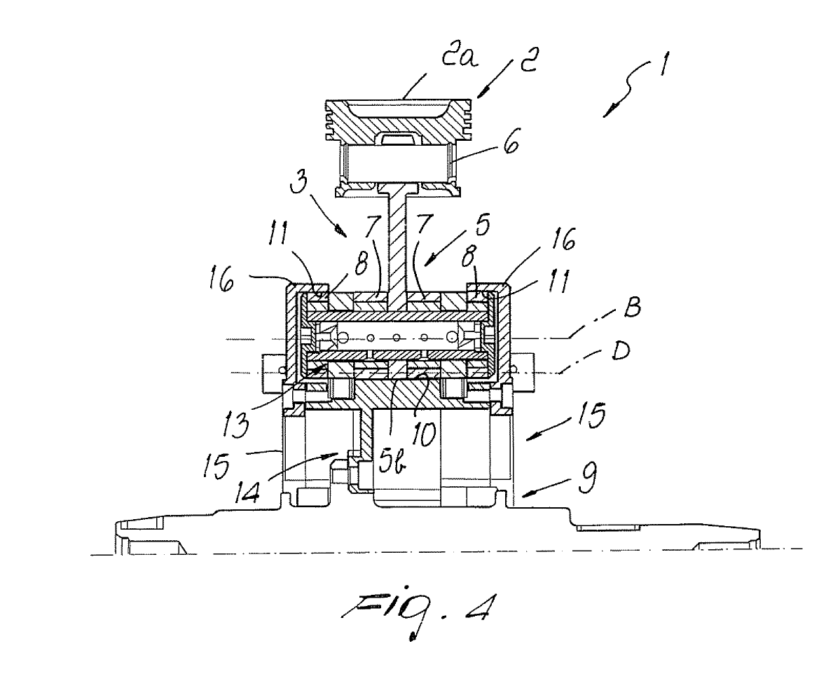

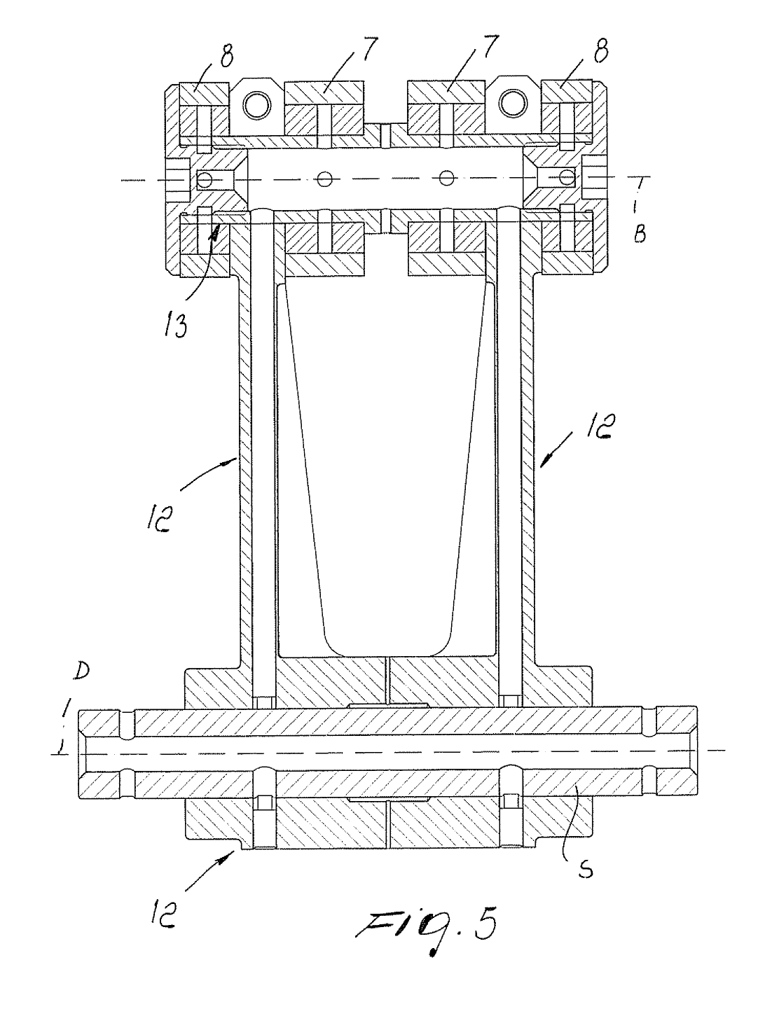

In the embodiment shown in FIGS. 1-5, the second end 5b of the push rod 5 is constituted by an eye, which supports a single supporting pin 13, on which two pusher rollers 7 and two return rollers 8 are mounted so that they can rotate.

The pusher rollers 7 are arranged symmetrically at the opposite sides of the second end 5b of the push rod 5 and follow a single pusher circuit 10.

The return rollers 8 are arranged symmetrically proximate to the sides of the pusher rollers 7 that lie opposite the second end 5b, the rotating contoured body 9 comprising two return circuits 11, along each of which one of the two return rollers 8 travels.

In the sequence of the return rollers 8 and of the pusher rollers 7, the former are end rollers and the latter can be arranged between them.

Again with reference to the first embodiment of the engine 1, the rotating contoured body 9 (FIG. 2) comprises a body 14, on the outer perimetric surface of which the pusher circuit 10 is provided, and two coupled bodies 15, which are substantially parallel thereto and are rigidly associated with its opposite faces.

A respective track 16 is formed in relief on the faces of the coupled bodies 15 that are directed toward the body 14, and its internal profile forms a return circuit 11.

In the alternative embodiment, shown in FIGS. 6 and 7, the second end 5b of the push rod 5 is fork-shaped, each prong being provided with a respective eye, which supports a respective supporting shaft 13; the two supporting shafts 13 are mutually coaxial.

A respective pusher roller 7 and a respective return roller 8 are mounted on each of the two pins 13; in the sequence of the pusher rollers 7 and of the return rollers 8, the former are end rollers and the latter are interposed between them. In this case, the rotating contoured body 9 comprises two pusher circuits 10, along each of which a respective pusher roller 7 travels, and two return circuits 11, along each of which a respective return roller 8 travels.

Again with reference to the second embodiment of the engine 1, the rotating contoured body 9 can be constituted for example by a structural element 17, on each opposite face of which there are two circuit tracks in relief; a first circuit track 18 and a second circuit track 19, both of which are internal but on two different levels and are mutually concentric.

The profile of the two first internal circuit tracks defines the pusher circuit 10 and the profile of the two second internal circuit tracks defines the return circuit 11.

However, alternative embodiments are not excluded in which the number and arrangement of the pusher rollers 7 and of the return rollers 8 changes and accordingly the number and arrangement of the pusher circuits 10 and return circuits 11 changes, or in which the configuration of the push rod 5, of the guiding arms 12 and of the rotating contoured body 9 changes, each being possibly provided monolithically, in two or more parts, or in any other form that may allow to achieve the aim and the objects and results of the system according to the invention.

In the particular embodiments shown in the figures cited above, the profile of the pusher circuits 10 and of the return circuits 11 comprises two lobes 20, which have respective mutually different circular arcs 21 and 22; the arc 22 allows rapid filling of the chamber during the fluid intake step, while the arc 21 produces the conditions for the stationary arrangement of the piston at the top dead center until explosion has occurred.

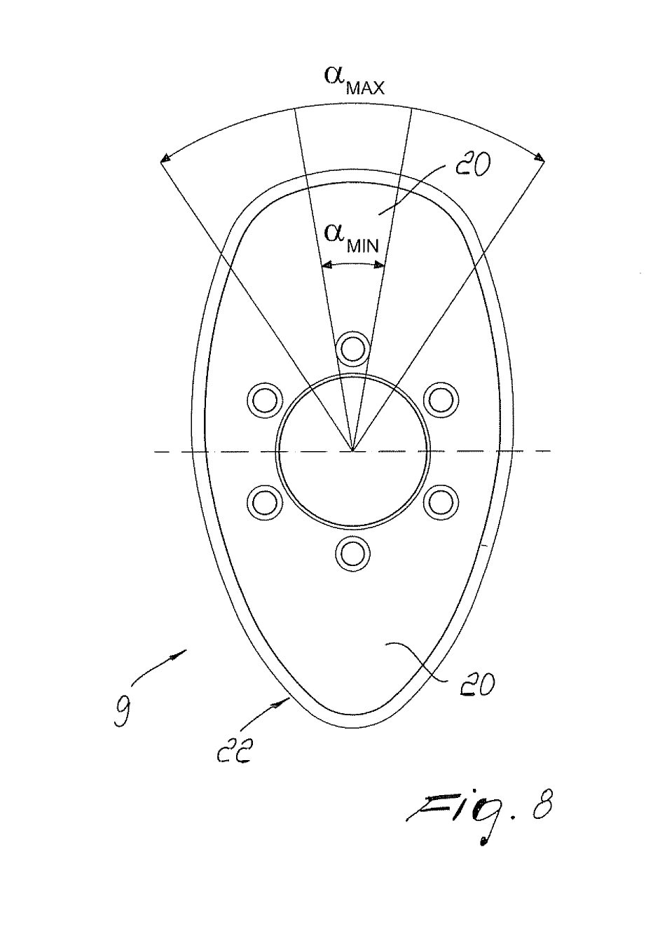

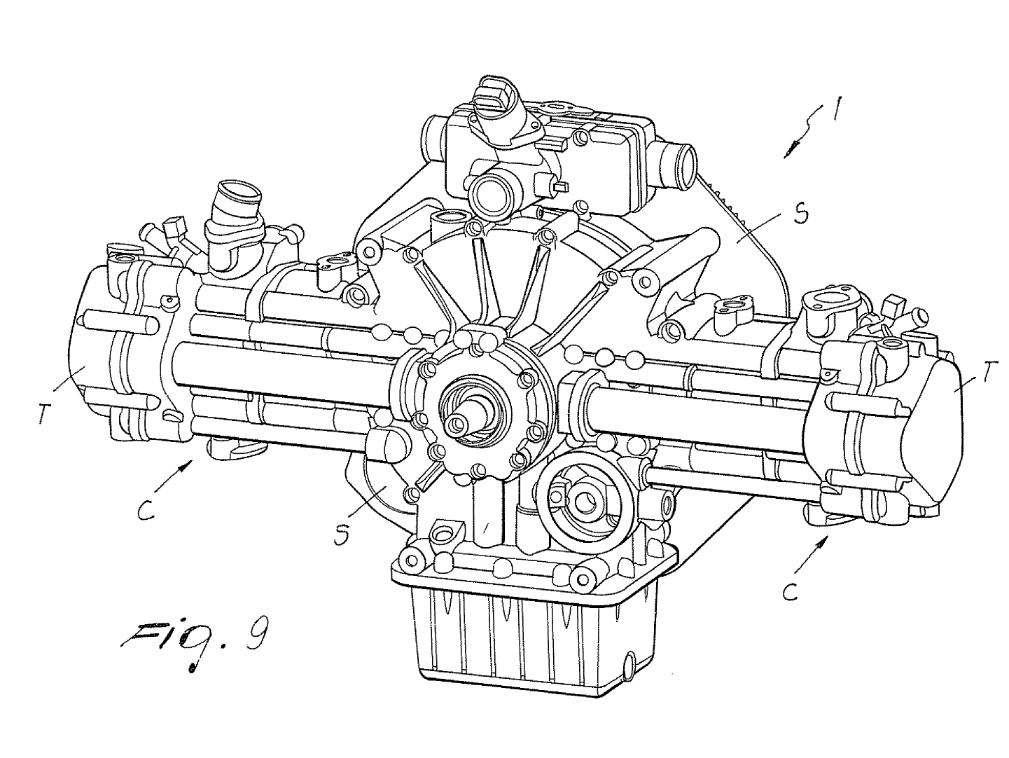

FIG. 8 illustrates the ideal embodiment of the rotating contoured body 9 which allows to provide and control the various steps of the engine; by means of a suitable and optimized circular arc 21, an ideal preset stationary angle is created in order to obtain the maximum power during the step of combustion at constant volume.

The engine 1 further has, due to the way in which it has been conceived, a flexibility in adjustment and functionality which can be adapted according to the sought performance requirements.

By adjusting and varying the sliding of the pusher rollers 7 and of the return rollers 8 along the respective circuits, when the piston 2 is proximate to the top dead center it is thus possible to keep the push rod 5 in a substantially stationary condition over a preset rotation angle.

The very geometry of the rotating contoured body 9 in fact adjusts and controls the mechanism in all of its steps.

When the piston 2 is at the TDC, which corresponds to the combustion step, the chamber formed within the respective cylinder remains at a constant volume for a preset time interval, which is matched by rotation angles whose extent can vary between a minimum α_{MIN} and a maximum α_{MAX} (see FIG. 8), and at which the piston 2 remains stationary, allowing to provide a work cycle which is close to the ideal cycle hypothesized by Otto with combustion at constant volume, since this is the thermodynamic cycle that has the highest theoretical efficiency.

The volume of the evolution chamber remains substantially constant until explosion has occurred, generating considerably more power than any type of engine known up to now, reducing drastically the emissions of unburned gases into the atmosphere (due to the substantially complete use of the aspirated fluids), accordingly reducing consumption, thus converting into energy most of the aspirated fluid.

In summary, the engine according to the invention seeks to have the following advantages with respect to any type of traditional engine, and is thus revolutionary with respect to the current background art:
deliver at least twice the power for an equal displacement and rpm rate;
reduce drastically the consumption of fuel for an equal power yield;
eliminate almost completely the unburned exhaust gases emitted into the atmosphere;
allow the engine shaft to turn at an rpm rate which is equal at least to half (one third, one quarter) of the rpm rate of the pistons, thus facilitating the coupling of the engine and the transmission;
yield much higher torques at low rpm rates.

Further, it is important to note that depending on the stationary angle, the engine according to the invention can be optimized both in terms of power and in terms of noxious emissions at the exhaust.

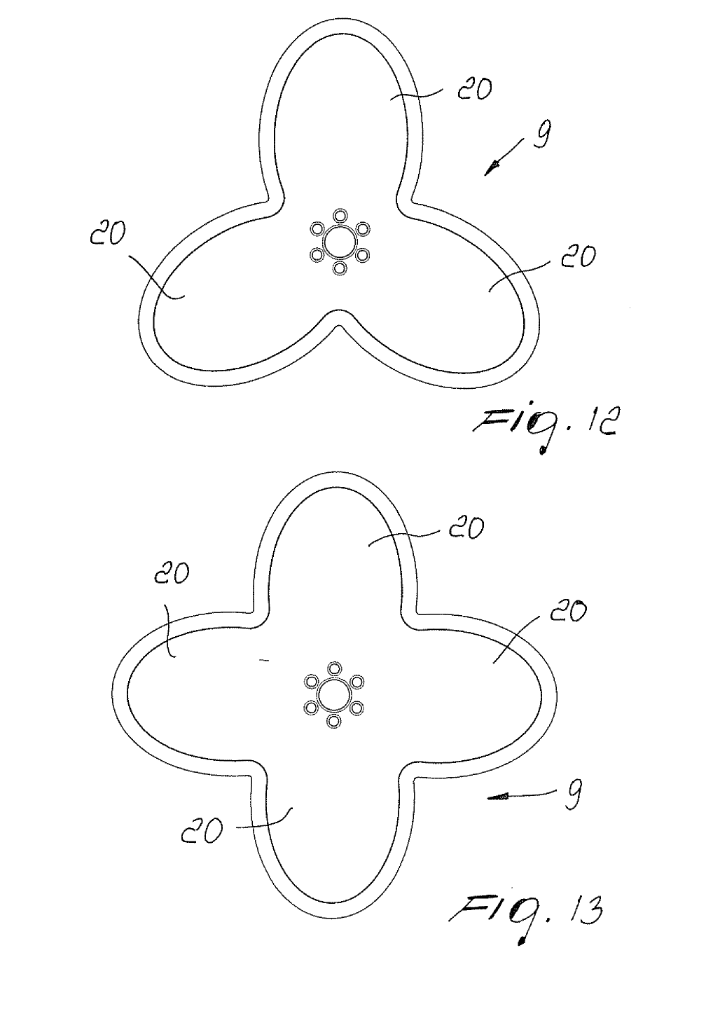

In alternative embodiments of the engine 1, the rotating contoured body (and therefore the pusher circuits 10 and the return circuits 11) can comprise three lobes, which are mutually radiused and offset by 120° with respect to each other (FIG. 12), or four lobes, which are mutually radiused and offset by 90° with respect to each other (FIG. 13), but embodiments with rotating contoured bodies with more lobes are not excluded.

During operation, the push rod 5, guided by the guiding arms 12, moves substantially with a reciprocating rectilinear motion along the axis of the cylinder, approximating the behavior of a traditional connecting rod-and-crank system, but with the advantage of moving as if it were a connecting rod of infinite length, thus avoiding lateral thrusts producing deformation, wear and noise in the steps for reversal and motion of the piston.

In a preferred embodiment, the engine 1 is sized so that when the piston 2 is halfway along the stroke between the TDC and the BDC, the guiding arm 12 forms an angle of substantially 90° with respect to the axis of the cylinder. This eliminates the oscillations that the push rod 5 would experience in any position that it might assume during the stroke of the piston between the TDC and the BDC, thus eliminating lateral thrusts on said piston, which in traditional engines cause ovalization, wear and noise of the various moving parts.

In practice it is found that the described invention can achieve the intended aim and objects.

With respect to known engines, the engine according to the invention, by having no inclination of the push rod in any position of its motion, allows in fact to eliminate all wedging, to reduce drastically all friction and accordingly limit the consequent energy dissipations, recovering them in terms of delivered power, eliminating the wear and damage of the various components; said invention further allows to reduce the weight of the moving masses and therefore mechanical efficiency is also improved, allowing the pistons to achieve a higher rotation rate.

By way of the rotating contoured body according to the invention, in the two-lobe solution the rpm rate of the engine shaft is halved with respect to the rpm rate of the piston, or is reduced to one third (in the case of three lobes) or to one quarter (in the case of four lobes).

By way of example, in a four-lobe configuration of the rotating contoured body, assuming a rotation rate of the pistons of 10,000 rpm, the rotation rate of the engine shaft is reduced to 2500 rpm, allowing the invention to have considerably higher torques and at low rpm rates with respect to traditional engines.

In the engine according to the invention, the combustion step occurs according to an ideal cycle at constant volume according to the ideal cycle hypothesized by Otto; the piston is stationary proximate to the TDC for a rotation angle, whose extent can be predefined, of the rotating contoured body which is fixed to the engine shaft during which combustion occurs.

Depending on the definition of the breadth of the stationary angle, it is possible to control and modify the power level and to modify the level of emission of unburned gases into the atmosphere, allowing to provide for the first time an “inherently environmentally friendly” engine, the limits of which are yet to be discovered.

It is certainly possible to demonstrate the considerable reduction of consumption, which can vary from 40 to 50% less than a known engine of equal displacement; with the new invention, one has distinctly more delivered power by way of the combustion (explosion) which occurs at higher temperatures, which can be reached due to the constant volume, as a function of the stationary angle.

The improved engine according to the invention therefore allows to increase both thermodynamic and mechanical efficiency, increasing the power in output from the engine shaft and reducing both fuel consumption and the emission into the atmosphere of unburned polluting gases with respect to known engines.

By changing the profile of the pusher and return circuits on the rotating contoured body it is possible to vary the rule of motion of the pistons at the various steps.

Finally, the engine according to the invention is structurally compact and has a much lower weight and much smaller dimensions than any known engine for equal characteristics of power, displacement and rotation rate of the engine shaft.

The invention thus conceived is susceptible of numerous modifications and variations, all of which are within the scope of the inventive concept.

All the details may further be replaced with other technically equivalent ones.

In practice, the materials used, as well as the shapes and the dimensions, may be any according to requirements without thereby abandoning the scope of the protection of the appended claims.

The disclosures in Italian Patent Application No. MO2004A000345 from which this application claims priority are incorporated herein by reference.

1. An internal-combustion engine with improved reciprocating operation, comprising at least one hollow cylinder, which contains a chamber for the evolution of a working fluid and has one end closed by a head and the opposite end closed by a piston which can slide with a reciprocating rectilinear motion in said chamber between a bottom dead center, providing the maximum distance from said head, and a top dead center, providing the minimum distance from said head, and a device for converting the reciprocating rectilinear motion of said piston into a rotary motion of an engine shaft, characterized in that said conversion device comprises:
a push rod, which is substantially perpendicular to said engine shaft and in which a first end is connected to said piston and a second end is connected to at least one pin for supporting at least one pusher roller and at least one return roller; said rollers rotating in mutually opposite directions and being arranged so that their axis is substantially parallel to said engine shaft;
a rotating contoured body, which is fixed to said engine shaft and is provided with at least one pusher circuit, along which said pusher roller travels, and at least one return circuit, along which said return roller travels, arranged on a plane which is perpendicular to said engine shaft; said pusher circuit is substantially concentric and similar to said return circuit, and both circuits are arranged on two different planes inside or outside said contoured body;
at least one guiding arm, in which one end is associated with said pin for supporting said rollers and the opposite end is articulated so that it can move about an axis which is fixed and rigidly coupled to the structure of the engine and is substantially parallel to said engine shaft;
said pusher and return circuits comprising respective circular arcs for the sliding of said pusher and return rollers which, when the piston is proximate to said top dead center, are suitable to keep the push rod and the piston in a substantially stationary configuration over a predefined space or angle of rotation of said rotating contoured body, the volume of said chamber remaining substantially constant until explosion has occurred.

2. The engine according to claim 1, wherein said pusher and return rollers are substantially mutually coaxial.

3. The engine according to claim 1, wherein said return rollers are two and are arranged proximate to the opposite sides of said at least one pusher roller, said return circuits being two, one of said two return rollers traveling along each of said circuits.

4. The engine according to claim 1, wherein said pusher rollers are two and are arranged proximate to the opposite sides of said at least one return roller, said pusher circuits being two, one of said two pusher rollers traveling along each of said circuits.

5. The engine according to claim 4, wherein said return rollers are two, said return circuits being two, one of said two return rollers traveling along each of said circuits.

6. The engine according to claim 1, wherein said supporting pin forms the supporting axis of said pusher rollers and return rollers, which are mounted so they can rotate, and is associated with said guiding arm so as to form a sort of rigid oscillating structure which supports said second end of the push rod.

7. The engine according to claim 1, wherein it comprises an articulation pin, which defines said fixed axis and is associated with a support which is fixed and rigidly coupled to said structure and to which said opposite end of the guiding arm is articulated so that it can oscillate.

8. The engine according to claim 1, wherein said rotating contoured body comprises a first body, on which there is a sliding surface on which said pusher circuit is provided, and two second bodies, which are fixed to said first body rigidly and so as to be substantially parallel, and on which circuit edges are formed in relief, the internal profile of said circuits forming respective return circuits.

9. The engine according to claim 1, wherein said rotating contoured body comprises a structural element on which two mutually opposite faces are formed, two circuit tracks being formed in relief thereon, both tracks being internal, their profiles forming respective pusher and return circuits.

10. The engine according to claim 1, wherein said pusher and return circuits comprise at least two lobes arranged at 180°.

11. The engine according to claim 1, wherein said piston, at the top dead center, is substantially stationary due to the radius of curvature and due to a rotation angle of said rotating contoured body which is comprised between a minimum value α_{MIN} and a maximum value α_{MAX} depending on the required performance.

12. The engine according to claim 10, wherein one of said two lobes of the rotating contoured body has an average radius which is different from the other one, said rotating contoured body being asymmetrical with respect to a substantially central plane.

13. The engine according to claim 1, wherein said pusher and return circuits comprise three lobes which are offset by 120° with respect to each other, the evolution of the working fluid in the chamber occurring through 240° of the rotation of the rotating contoured body.

14. The engine according to claim 1, wherein said pusher and return circuits comprise four lobes which are offset at 90° with respect to each other, the evolution of the working fluid in the chamber occurring through 180 of the rotation of the rotating contoured body.
